(19) United States
(12) Patent Application Publication
(10) Pub. No.: US 2002/0091994 A1
(43) Pub. Date: Jul. 11, 2002

(54) SYSTEMS AND METHODS FOR SOFTWARE EVALUATION AND PERFORMANCE MEASUREMENT

(76) Inventors: SCOTT C. MCCREADY, HARVARD, MA (US); GERRY J. MURRAY, UPTON, MA (US); JOHN HOPE, WATERTOWN, MA (US); PAUL REYNOLDS, WATERTOWN, MA (US)

Correspondence Address: FOLEY, HOAG & ELIOT, LLP, PATENT GROUP, ONE POST OFFICE SQUARE, BOSTON, MA, 02109, US

(21) Appl. No.: 09/177,404

(22) Filed: Oct. 23, 1998

Related U.S. Application Data
(60) Provisional application No. 60/063,255, filed on Oct. 24, 1997.

(51) Int. Cl. G06N 7/04; G06F 9/44

(52) U.S. Cl. 717/124

(57) ABSTRACT

A process for analyzing financial data associated with deploying a software product to aid an organization in a purchase evaluation of the software product is provided. The process provides a knowledge base having a first set of information representative of criteria that have been empirically determined to provide a financial analysis of the software product. The process then collects, in a form of a user response to a set of questions, a second set of information representative of factors involved in the deployment the software product to aid in the financial analysis. The first and second sets of information are thereafter processed to generate a result representative of the financial analysis.

### RELATED U.S. APPLICATION(s)

The present application claims priority from U.S. Provisional Application No. 60/063,255, filed Oct. 24, 1997 which is hereby incorporated herein by reference.

### TECHNICAL FIELD

The present invention relates to systems and methods for identifying the costs and benefits associated with the deployment of a variety of software technologies, to aid in the evaluation of a purchase of such software technologies.

### BACKGROUND ART

Software products are increasingly being purchased by users and organizations in a variety of different industries, and particularly by those that are concerned with the impact of information technology (IT) on their business operations. The purchase of software products and/or the upgrade of the technology infrastructure to support the software product, however, can be quite expensive. In the past ten or so years, U.S. businesses have spent more than one trillion dollars on information technology. The impact of this expenditure, particularly on the productivity of white-collar workers, interestingly, has been marginal. As a result, many organizations have been resistant to investing in new software technology, unless a positive financial impact on their business operations can be demonstrated. The pressure, therefore, has been put on the IT decision makers, at many of these organizations, to justify the investment in any new technology with a formal Return on Investment (ROI) analysis. However, a substantial number of IT professionals have no formal education in finance or training in ROI analysis.

Currently, one of the few means for which organizations, and the IT professionals at these organizations, have available in order to rationalize a purchase of a new software technology and to determine the ROI impact of the new information technology on their businesses is to spend a large amount of money, usually tens of thousands of dollars, on independent consultants. In 1996 alone, more than 143,000 purchase decisions were made for software products, many of which were made only after employing the help of expensive consultants. The number of purchase decisions is expected to grow at better than thirty (30) percent through the year 2000. Yet the need to pay an expensive consultation fee for the ROI analysis just so that a software purchase can be made may have already deterred some organizations from making such a purchase, particularly when the consultation fee significantly increases the burden on the already expensive information technology purchase.

Software vendors, although having done a tremendous job of coming up with new features and functions for their software products in response to customer demands, have, for the most part, been unable to provide the customers with a credible measure of the impact the software product will have on the customers' business. New software products are often purchased initially by those interested in the added technological advantages. The number of these purchasers, however, is small. The larger market lies in those organizations motivated by how a new software product will improve their business operations. As a result, the sales of many software technologies slow as the products move from the early stage of their life cycle to the mainstream stage when the products become more visible to the larger market.

To combat this scenario, in some instances, vendors of new software technology have responded to the demands of the organizations by hiring independent consultants to perform impact analyses, including the costs and benefits of the vendor's software product on the business operations of these organizations. As an example, in 1994, IDC completed one of the most notable costs and benefits studies when it documented the financial impact of Lotus Notes at sixty five (65) customer sites in twelve (12) different industries and thirteen (13) different countries. The study showed that Lotus Notes was able to demonstrate an average three year ROI of about one hundred seventy nine (179) percent. To date, more than 155,000 copies of this study have been published and distributed, and the study remains a key portion of the Lotus marketing strategy to new organizations making a decision to purchase Lotus Notes.

IDC has completed numerous additional ROI studies since the original Lotus Notes study. Each new study has garnered rapid attention from the media and prospective customers alike. Despite the voluminous reports produced by the studies, organizations interested in purchasing new software technology continue to review the reports in hope of processing the information, and in some way extrapolate the productivity implications for their own organizations. Based on the demands for these studies, it is clear that potential purchasers of new information technology are hungry for information that will help them understand the financial implications associated with their purchase.

As organizations wishing make significant new information technology purchases must continue to weigh between a requirement for an ROI analysis and the need to pay an expensive consultation fee for the ROI analysis, particularly when the consultation fee can significantly increase the burden on the already expensive potential technology purchase, there remains a need for a product which would permit these organizations to make a reasonably quick and accurate ROI analysis using few criteria, so as to avoid the burden and the fees typically associated with such an analysis.

### SUMMARY OF THE INVENTION

In accordance with one embodiment of the present invention, there is provided a process for analyzing financial data associated with deploying a software product to aid an organization in a purchase evaluation of the software product. The process initially provides a knowledge base having a first set of information representative of criteria that have been empirically determined to provide a financial analysis of the software product. The first set of information, in one embodiment, includes, but is not limited to, the costs for upgrading current technology infrastructure in connection with the utilization of the software product, the costs for training and supporting users in connection with the utilization of the software product, and the benefits relating to time, operation and/or payroll savings in connection with the utilization of the software product.

The process next collects, in a form of a user response to a set of questions, a second set of information representative of factors involved in the deployment the software product to aid in the financial analysis. The second set of information, in a preferred embodiment, includes data regarding an industry within which the software product is to be utilized, data regarding a total number of users utilizing the software product, data regarding an average salary amount for each user utilizing the software product, data regarding the manner and scope of utilization of the software product within the organization, and data regarding the level of experience of the organization in a client/server deployment.

The process then processes the first and second sets of information to generate a result representative of the financial analysis. In other words, the results generated, based on the responses provided, illustrate of the costs and benefits to the organization when a software product of interest is deployed.

In accordance with another embodiment of the invention, a knowledge base having information representative of criteria associated with a financial analysis for a purchase of a software product is provided. The knowledge base includes, in an embodiment, question information representative of questions for collecting variable information from a user. The variable information to be collected are generally information regarding the environment within which the software product will be deployed. Examples of questions asked include, the industry in which the organization operates, the number of users expected to be using the software product to be employed, the average salary of per user, the scope of utilization (i.e., whether the software product will be used in a specific department, enterprise-wide etc.), the organization's experience in deploying new software technology, and the level of automation available for implementing a new software product. The knowledge base also includes, sets of empirically determined data representative of costs and benefits associated with a purchase of a specific software product. The sets of empirically determined data, which include data regarding the costs to upgrade an organization's current technology infrastructure in connection with the utilization of the software, the costs of training and support the users, and the benefits relating to time, operation and/or payroll savings, are organized in such a manner so as to be accessed as a function of the variable information collected from the user.

In another embodiment of the invention, a process for guiding a user in a purchase of a software product is provided. The process includes initially asking at least one question to obtain from a user, variable information representative of an environment within which the software product will be deployed. Next, a set of empirically determined data is selected from a knowledge base, as a function of the variable information provided by the user. Thereafter, the selected set of empirically data is applied to a spreadsheet having empirically determined formulas for performing a financial analysis, so as to obtain information representative of a financial analysis as a function of the selected set of empirically determined data. Once the financial analysis information is obtained, it is displayed in order to guide the user in the purchase of the software product.

### BRIEF DESCRIPTION OF THE DRAWINGS

FIG. 1 illustrates, in accordance with one embodiment of the invention, a functional process for providing and employing a system for determining a financial analysis of a specific software product to be purchased.

FIG. 2 depicts a graphical user interface for requesting a response from a user regarding the level of detail for implementing the financial analysis.

FIG. 3A depicts a graphical user interface for obtaining information from the user regarding the various constraint variables regarding the users and the industry within which the software product being considered is to be used.

FIG. 3B depicts a pull-down menu for one of the variables provided in FIG. 3A.

FIG. 4 depicts graphical user interface for obtaining information from the user regarding the various constraint variables regarding the environment within which the software product being considered is to be used.

FIG. 5 depicts a graphical user interface for obtaining information from the user to quantify the costs as they relate to the user's expertise or access to expertise for deploying a specific software product.

FIG. 6 depicts a graphical user interface for obtaining information from the user to quantify the benefits as they relate to the user's expertise or access to expertise for deploying a specific software product.

FIG. 7 is a graphical display of the financial analysis in terms of various costs associated with deploying a specific software product, in accordance with one embodiment.

FIG. 8 is a graphical display of the financial analysis in terms of various benefits associated with deploying a specific software product, in accordance with one embodiment.

FIGS. 9-12 are graphical displays of the financial analysis showing the relationship between the costs and the benefits associated with deploying a specific software product under various.

FIGS. 13-14 are tables displaying the sets of information stored within the knowledge base as provided in accordance with one embodiment of the present invention.

FIG. 15 illustrates a spreadsheet formula for use in a financial analysis in accordance with one embodiment of the present invention.

### DETAILED DESCRIPTION OF SPECIFIC EMBODIMENTS

As used herein, “Return On Investment” or “ROI” means a method to evaluate and compare the attractiveness of one business investment to another expressed as a certain percentage over a number of years. For example, a three year ROI of 150% means that the benefits you accrue are one and one-half times greater than the costs and resources necessary to implement a project.

As used herein, “Net Present Value” or “NPV” means a value obtained by summing the present value of the net benefits for each year minus the initial costs of the project. A positive NPV means that the project generates a profit. A negative NPV means that the project generates a loss.

As used herein, “Payback Period” or “Payback” means the time it takes for a project to recoup the funds expended. This period is typically expressed in years or months.

As used herein, “Internal Rate of Return” or “IRR” means the discount factor which needs to by applied to an annual benefit for a Net Present Value of a project to equal zero. In other words, it is the percentage rate which the benefits must be discounted until the benefits equal the costs.

The systems and methods of the invention will be described herein with reference to certain illustrated embodiments for allowing a user to determine a return on investment signal representative of a cost benefit analysis performed for the purpose of determining the value of a commercial software package. However, although the illustrated embodiments are directed to systems and methods for performing a financial analysis to determine the value of a software product, it will be understood that the systems and methods described herein can be employed in other applications including any application wherein a decision to purchase a piece of capital equipment would benefit from a prior financial analysis, such as a return on investment analysis, or a net present value analysis Moreover, it will be understood that the systems and methods described herein can be employed for determining any type of financial analysis, and are not to be limited to the ROI, NPV, or other financial analyses described herein.

The systems and methods of the invention include computer programs and computer implemented methods that allow a prospective purchaser to perform a financial analysis on a proposed purchase of a software product. The systems and methods described herein include expert systems that guide the user through the financial analysis process to collect a reduced set of information from the user. The collected set of information is employed to access information contained within a knowledge base. The knowledge base contains empirically determined data that includes data applicable to a calculation of the value of the software product to that user. The information selected from the knowledge base can be applied to a computer program, such as a spread sheet, capable of processing that data to determine a financial analysis (i.e., cost/benefit analysis) signal representative of the value of the software product to that user.

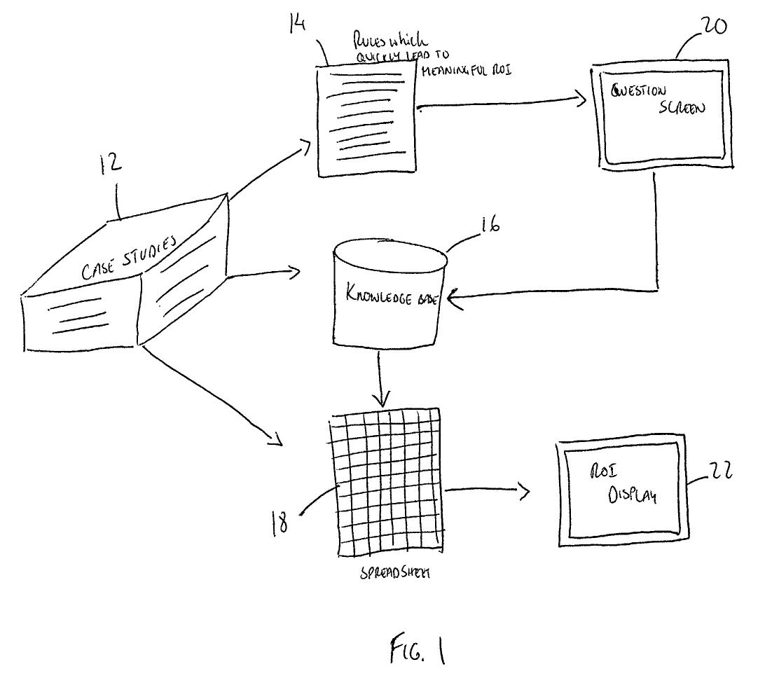

FIG. 1 depicts functionally a process for providing and employing a system 10 for determining the financial value of a software product for a given user. Specifically, FIG. 1 depicts a source of information 12 (hereinafter “knowledge source”), such as a series of case studies related to the costs and benefits of deploying the software product being considered by a user. FIG. 1 further depicts a set of rules 14 for use in the financial analysis process. The analysis rules 14 are generated from processing empirically the information contained within the knowledge source 12, a knowledge base 16 having stored therein information representative of factors that have been empirically determined to be relevant to a cost/benefit analysis being performed on a particular software product, a computer processor 18 illustrated in FIG. 1 as a spread sheet program, an interface screen 20 capable of providing information to a user and collecting information from the user, and an interface screen 22 capable of displaying the results of a financial analysis to the user.

FIG. 1 graphically depicts that the knowledge source 12 can be employed to generate the analysis rules 14, the knowledge base 16, and a value model implemented within the processor 18. In one embodiment, the knowledge source 12 comprises a plurality of case studies, each of which contains information about the deployment of the particular software product that the user is interested in purchasing. The case studies typically include a financial analysis of the value of that product to a particular type of organization. For example, in one embodiment, the case studies can be directed to different companies which have analyzed the value of the PC Docs document and knowledge management solution. The different case studies can look at the PC Docs document and knowledge management valuation in light of the different user demands. For example, the PC Docs software product can be purchased for deployment at a discrete site, such as at one station within a company. Alternatively, the PC Docs system can be purchased for an enterprise-wide application wherein the PC Docs system is deployed across each computer station within the company. Moreover, the knowledge source 12 can include case studies which consider different size organizations, for instance, from sole proprietorships to large corporations that have thousands of employees with a number of physically separated locations. Additionally, these case studies can include evaluations of the PC Docs document and knowledge management software product for use in different industries, such as the legal industry, finance industry, government, high technology, or any other suitable industry. Each of the case studies typically includes a complete financial analysis that was developed with a spread sheet, such as Microsoft Excel, and which was employed to develop a meaningful understanding of the financial value of the software product to the business operation of that particular company.

FIG. 1 further illustrates that the knowledge source 12 can be used to provide a source of empirical data that contains information to be employed in the identification of a set of constraints, or criteria, that can arise from a particular user's needs, and which can lead to a framework for defining the appropriate financial analysis for the software product that is described in the case studies. For example, it is understood that an analysis of the information provided by the knowledge source 12 shows that information about the user is a useful constraint that can be applied to the financial analysis. Similarly, an analysis of the knowledge source 12 indicates that other useful constraints may include the manner in which the user expects to deploy the technology, the level of experience the user has in deploying client/server architectures or in deploying other types of software relevant to the software product being considered by the user, and the extent to which the process that the user is considering upgrading with the purchase of the software product is currently automated. These constraints are understood to lead to a definition of the user's evaluation problem, which then allows for the selection of a proper framework for performing the financial analysis in solving the user's evaluation problem. Although the described constraints have been shown through experimentation to yield useful financial analyses, it will be understood by one of ordinary skill in the art that other constraints can be substituted or added to the list set forth above without departing from the scope of the invention, and that the present invention is not to be limited to the constraints described above, or limited to the constraints shown in the embodiments described herein. The embodiments provided are solely for illustrative purposes.

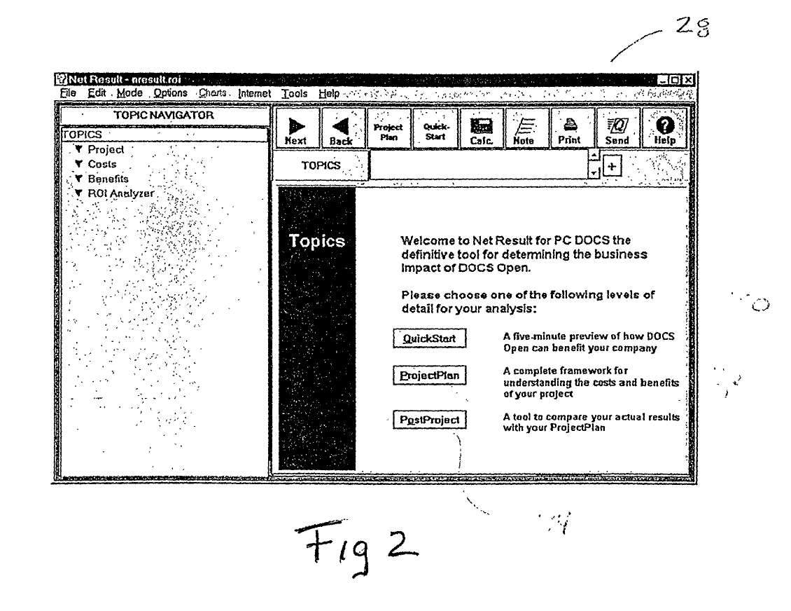

FIG. 1 further shows that the constraints depicted by element 14 can be displayed to the user through a series of screens 20 that can be presented on a computer monitor for allowing the user to read the display and enter information into the system, which information then can be collected and employed by the system. Turning to FIGS. 2-6, a set of exemplary displays are provided. FIG. 2 depicts a graphical user interface, such as those typically employed with the Windows operating system and suitable for inputting data into the system. The display 28 illustrated in FIG. 22 offers a user, in one embodiment of the invention, three different choices for analyzing the purchase of the PC Docs Document Management tool. To this end, the display 28 includes three components, shown as buttons 30, 32 and 34. Each of the depicted components is a standard windows-type component that can direct the operating system to send a message to the underlying application program, which subsequently can process the message to respond to a user's response or input. For the example, as shown in FIGS. 2-6, it will be assumed that a user activates component 30 to begin the “quick-start” financial analysis process which employs the constraints described above for defining a framework for analyzing the cost and benefits of the user's considered software purchase.

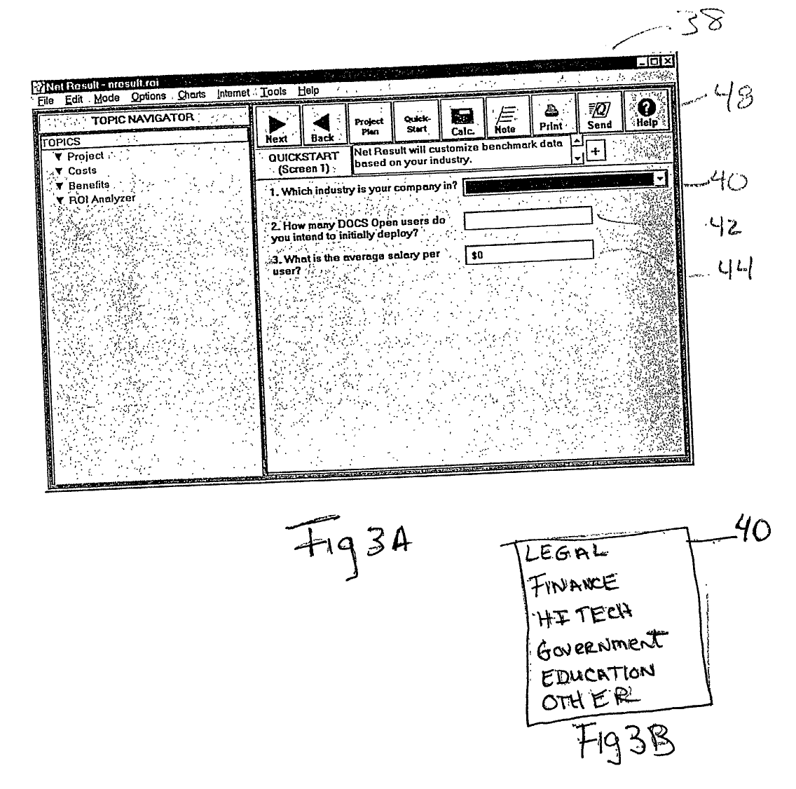

FIG. 3A depicts a first screen 38 that is displayed for the user to collect information regarding the first constraint, that is information about the users who will be employing the software product being considered. As shown in FIG. 3A, the display 38 presents to the user three questions. The first question, in one embodiment, can be “WHICH INDUSTRY IS YOUR COMPANY IN?” This first question directs the user to enter information representative of the type of industry in which the perspective users are involved. To this end, the display 38 includes a listbox 40, shown in FIG. 3B, as a conventional listbox component element provided under the Windows monitoring system. When the listbox 40 is activated, by activating the arrow on the right, the listbox 40 presents to the user a number of selections, each of which is representative of a particular industry. For example, upon activation of the listbox 40, the user can be presented with a selection of industries, such as those depicted in FIG. 3B, including LEGAL, FINANCE, HI TECH, GOVERNMENT, EDUCATION, and OTHER. The user then can select an appropriate entry which will be displayed in the top of listbox 40.

FIG. 3A further depicts a second question, in particular “HOW MANY DOCS OPEN USERS DO YOU INTEND TO INITIALLY DEPLOY?” This second question is presented along with a textbox 42, into which a user can enter text. The display 38, therefore, permits the user to enter, into the textbox 42, a numerical value that is representative of the number of DOCS OPEN USERS that the user wants to have considered in the financial analysis.

The display 38 shows a third question, “WHAT IS THE AVERAGE SALARY PER USER?” This third question is presented to the user along with a textbox 44, similar to the textbox 42 depicted above. Into the textbox 42, the user is expected to enter a numerical value representative of the average salary, in dollars, per user expected to use the software product under consideration.

Once all the information has been entered into display 38, the user can employ control buttons set forth in the control bar 48, see FIG. 3A. Continuing with the present example, once the user has entered all information that is requested by the display 38, the user can activate the NEXT button of the control bar 48 for directing the application program to proceed to the next step.

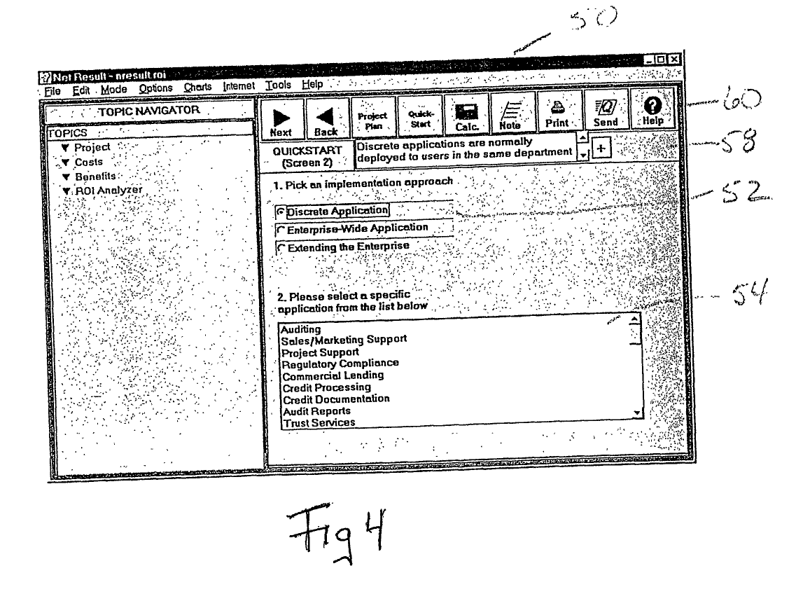

This next step is depicted in FIG. 4, which provides a display 50 for collecting, from the user, information which is representative of the scope or the manner in which the user expects the software product under consideration to be deployed at the user's site. In particular, the display 50 includes the input fields 52 and 54, a message box 58, and a control bar 60. The first input field 52 includes a plurality of buttons that offer the user a discrete number of choices. The user can select one of the buttons for defining the implementation approach that will be employed at the user's site. In particular, the input field 52 offers the user a set of choices that includes “DISCRETE APPLICATION”, “ENTERPRISE WIDE APPLICATION” and “EXTENDING THE ENTERPRISE.” The depicted embodiment is preferable, as the button permits the user to select only one of the proposed implementations. The depicted display 50 also provides an optional message box 58 that can be operated in concert with the buttons presented by input field 52. In particular, upon selection of a particular button in input field 52 for a particular choice, the message box 58 can present a message to the user that is representative of a definition of the choice the user is considering. For example, as shown in FIG. 4, display 50 shows an input field 52 in which the “DISCRETE APPLICATION” selection has been chosen by the user. In cooperation with this selection, the message box 58 presents a message to the user that recites “DISCRETE APPLICATIONS ARE NORMALLY DEPLOYED TO USERS IN THE SAME DEPARTMENT.” This message information is provided to guide the user in making the appropriate selection for the implementation approach.

FIG. 4 further depicts an input field 54. Input field 54 permits the user to select a specific application from the presented list. The user can select, from the options in the input field 54, the most appropriate option for defining the use of the software product under consideration.

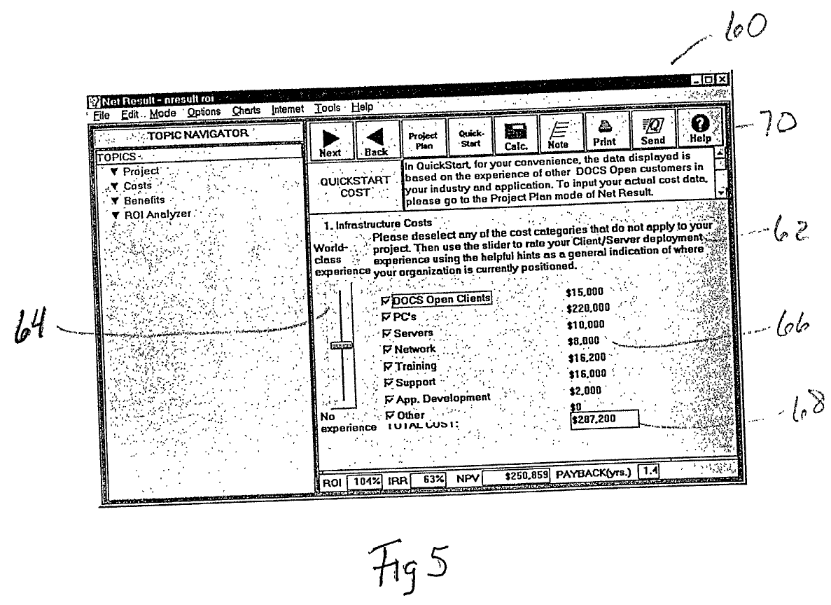

FIG. 5 depicts a display 60 for collecting, from the user, variable information to quantify a constraint that characterizes the user's expertise, or access to expertise with deploying software products similar to software product under consideration. For example, the display 60 can be employed to gather, from the user, information that quantifies the user's experience with deploying a client/server architecture, if the software product under consideration is a client/server product. It is understood that this constraint can have a substantial impact on the cost side of a cost/benefit analysis, such as an ROI analysis. For example, an analysis of the knowledge source 12 can indicate that a user's previous client/server experience can have a direct impact on what it will cost the user to acquire the new software functionality. This can arise, for example, from the fact that a customer thinking of purchasing a software product requiring a certain technology infrastructure, namely, PC's, networks, telecom equipment, may have a financial barrier of interest that is at least partially determined by whether this infrastructure, or portions of this infrastructure are already available to the user. Analysis of the knowledge source 12 can also indicate that the more experience a user has in deploying a client/server technology, the cheaper it can be for the user to upgrade the existing infrastructure to accommodate new software technology. Moreover, such an analysis may further indicate there may even be less effort and cost in support activities, such as like training and application development.

Turning again to FIG. 5, it can be seen that the display 60 includes a text field 62 that directs the user to enter information representative of the user's experience with client/server deployment. Display 60 further includes a slider bar 64 that provides a graphically manipulatable icon, which can be employed to allow the user to quantify the user's experience. To this end, the slider bar is provided with minimum and maximum settings to correspond to “NO EXPERIENCE” or “WORLD-CLASS EXPERIENCE” levels of experience. FIG. 5 further shows that the display 60 includes a list of infrastructure items, such as PC's, servers, training, each of which are considered in the financial analysis as classed factors that vary according to the experience of the user. Associated with each of these infrastructure items is an evaluation that is presented to the user both in an itemized form in field 66 and as a total cost 68. In the embodiment depicted in FIG. 5, the application program that generates the display 60 allows a user to manipulate the slider bar 64, and in response to movement of the slider bar 64, dynamically alters the numerical values associated with the infrastructure items depicted in field 66. Thus, as the user raises and lowers the slider bar 64 the numerical values presented to the user can increase and decrease accordingly, thereby changing the total cost 68 presented to the user. The embodiment depicted by FIG. 5, therefore, provides a dynamic evaluation of the costs associated with the infrastructure necessary for deploying the software product under consideration. It will further be noted that in an optional embodiment the system can provide to a user guidance in selecting the proper experience level for the user. To this end, the user interface can provide message boxes to the user, including pop-up boxes that appear in response to the user's movement of the slider in slidebar component 64. For example, in one embodiment, as movement of the slider bar is detected, a pop-up message box is presented on the display 60 to provide the user with a definition of the experience level which would be associated with the location which the user has presently selected for the slider bar. Accordingly, in this embodiment, if the user were to position the slider bar at the bottom, the “NO EXPERIENCE” setting, the user interface could provide a pop-up box that states a definition of the “NO EXPERIENCE” setting, which could include the statement “NO TRAINED ON-SITE IS STAFF, OR THE ONLY IS STAFF AVAILABLE NEEDS TRAINING AND SUPPORT IN DEPLOYING APPLICATION PROGRAMS THAT ARE DISCRETELY LOCATED ON COMPANY PCS.” Similarly, if the user were to raise the slider bar to the top setting “WORLD CLASS EXPERIENCE”, the user interface can provide a message box that displays the message “ON-SITE IS STAFF THAT HAS SUCCESSFULLY DEPLOYED CLIENT/SERVER ARCHITECTURES ACROSS THE EXISTING NETWORK WITHOUT OUTSIDE SUPPORT.” Information System (IS) staff having established protocol for training users, and skills in developing application programs for deployment across the network. Other message boxes can be presented to the user if the user selects a setting in-between the minimum and maximum ranges. Once the user has selected the appropriate experience level, the user can activate the NEXT button in the control bar 70 to proceed to providing the system with information regarding the next constraint.

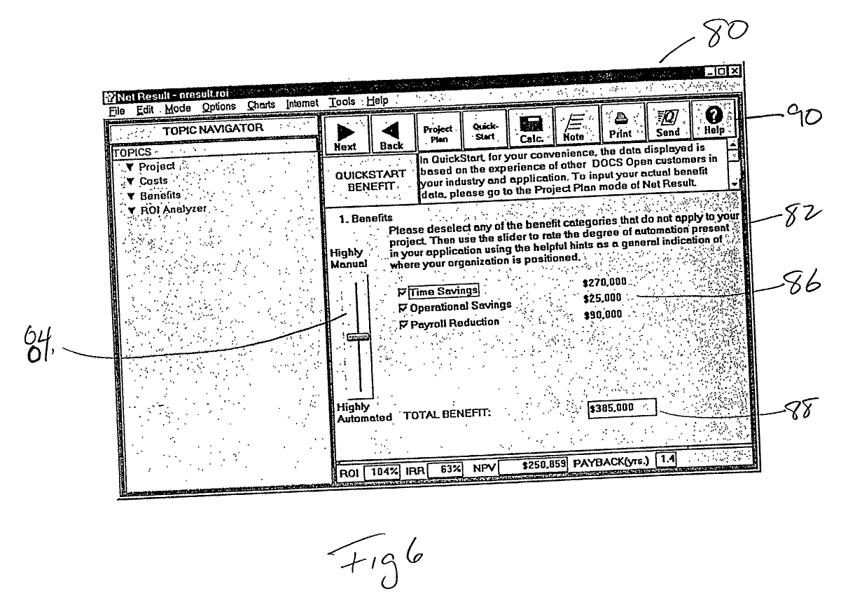

Turning to FIG. 6, it can be seen that after activating the NEXT button, the system can present to the user the illustrated display 80. The depicted display 80 includes a text field 82 that requests the user to enter variable information regarding the constraint of interest. For the depicted screen 80 the constraint of interest includes information about the degree of automation that is currently present in the application. This constraint seeks to quantify the benefits that can be provided to the user by employing the software product under consideration. It is understood from an analysis of the knowledge source 12 that a strong relationship exists between the benefits that could be achieved from deploying a new software technology, and the current degree of automation existing in the task that will be turned over to the software product under consideration. For example, an analysis of the data collected in the knowledge source 12 indicates that the more manual a process, the more productive benefits can be had from automation. If a process is already highly automated then the benefits are likely to be lower. Alternatively, if a process is largely performed in a manual manner, then the benefits of deploying the new software technology to replace the existing manual system, is likely to lead to greater benefits. To allow the user to quickly quantify the degree of automation, the display 80 includes the slider bar 84 which can be set between the ranges of “HIGHLY AUTOMATED” and “HIGHLY MANUAL.” Display 80 also includes a list of benefits including time savings, operational savings, and paper reduction. Each is provided with a numerical value in field 86 that corresponds to a financial benefit achieved from automating the present task. The total of benefits is also provided in the field 88. Similarly, with respect to the user interface 70, the user can manipulate the slider component 84 to select a degree of automation for the present task. The user can use the slider 84 to position his company at the appropriate point on the scale. As the user moves the slider up and down the scale, there can be help messages which guide the user as to where he may want to place the company on the scale. At the same time as the slider 84 moves up and down the scale, the display of the benefit numbers changes in real time. For example, in the display depicted in FIG. 6, the evaluations provided by field 86 for time savings, operational savings and payroll reductions can vary as the user changes the degree of automation setting. Moreover, for the embodiment depicted in FIG. 6, the user interface can provide dynamic financial results that can be displayed at the bottom of the screen, including ROI, IRR, NPV, PAYBACK and any other suitable measure of financial benefit. These results can change as the user moves up and down the cost and benefit experience slider 84.

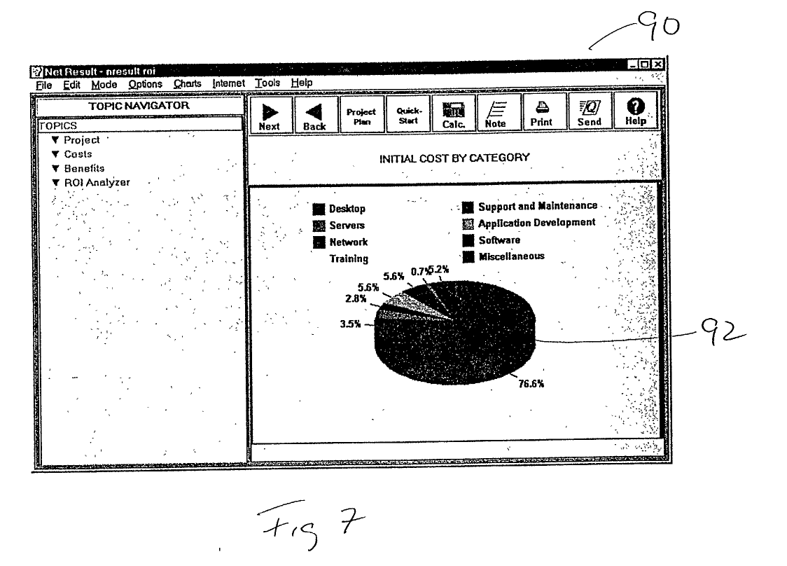

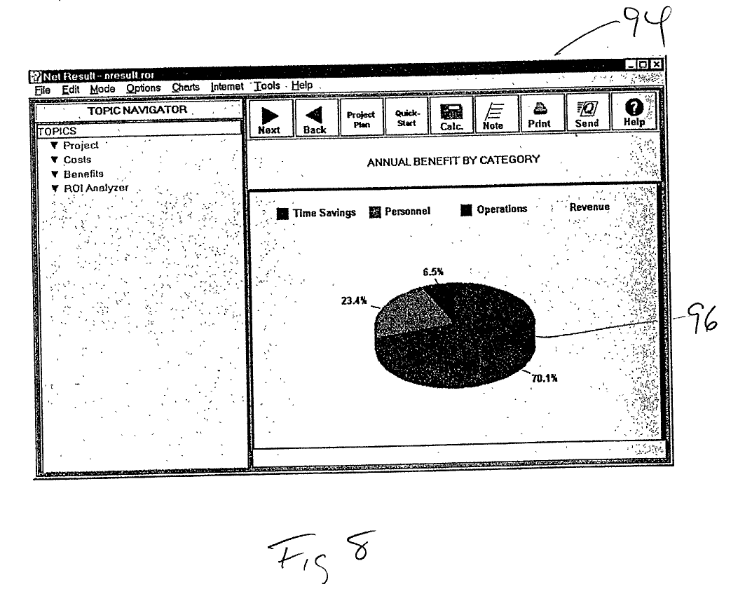

FIGS. 7-12 depict graphical displays that optionally can be presented to a user to describe, in more detail, the costs and benefits associated with the proposed purchase of the software package. For example, FIG. 7 presents a display 90 that includes a pie chart 92. The pie chart 92 shows, graphically, the percentage of initial costs, by categories, for the infrastructure and other elements associated with the proposed purchase. FIG. 8 presents a display 94 that presents a pie chart 96 which shows, in percentage, the annual benefits by category of the proposed software purchase. Such benefits include time savings, personnel, operations, and revenue.

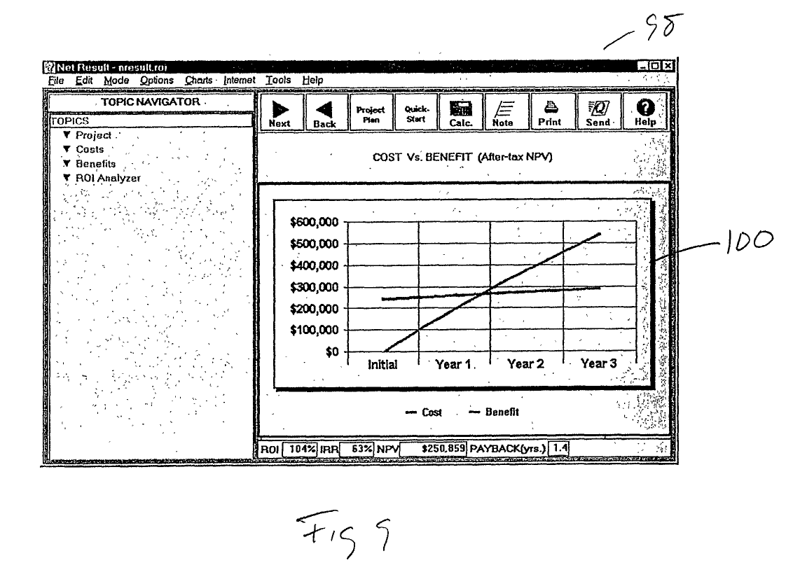

Turning to FIG. 9, the financial analysis associated with the proposed purchase of the software package can be displayed in an alternate format. In particular, display 98 provides a “cost v. benefit” graphical image 100 of the financial analysis results in a line graph format rather the pie graphs shown in FIGS. 7-8. The graphical image 100 also shows, over a three year period, the values associated with benefits relative to the costs.

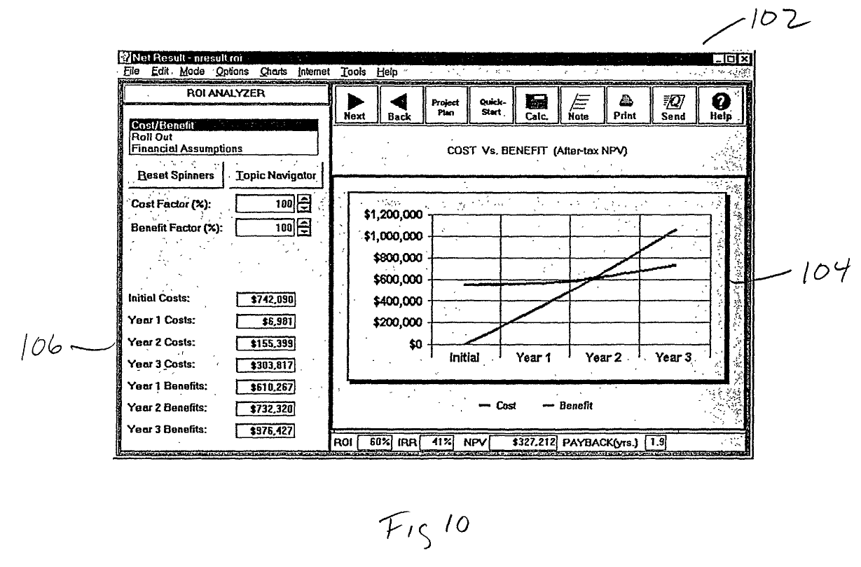

Once the financial analysis results have been provided, there may be “what-if” situations, wherein the user may want to see how the cost/benefit analysis may be affected if some criteria are altered. In FIG. 10, a display 102 permits the user to alter the cost and benefit factors in field 106, in the event such factors were initially underestimated or overestimated by the user, when the constraint information were first provided. Thus, for example, by increasing the costs and/or benefits by a certain percentage, for example, 100% as shown in FIG. 10, the user is able to see the shift in the costs and benefits over a period of time, from graphical image 100, shown in FIG. 9, to graphical image 104, shown in FIG. 10.

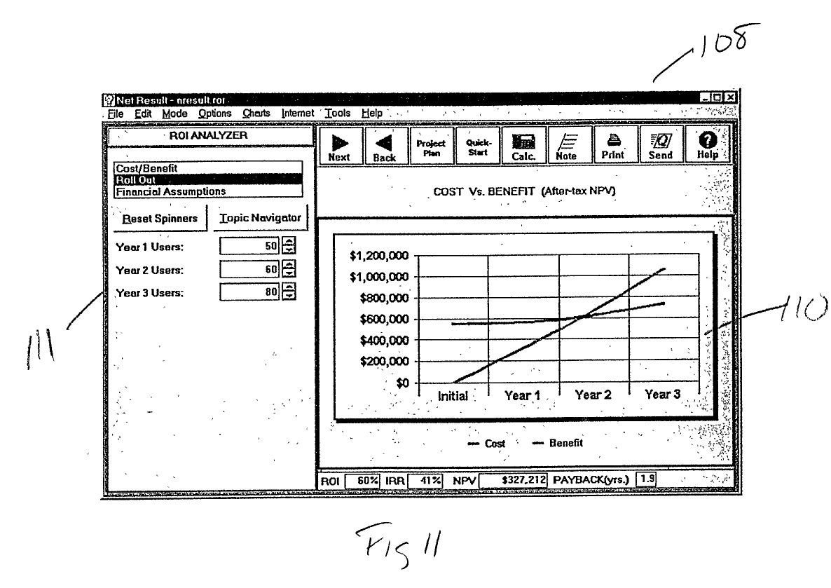

Turning to FIG. 11, a display 108 permits the user to play out another “what-if” situation, in particular, when altering the year-by-year roll out criteria (i.e., availability of the software program to employees in a company) in field 111, for the software program. For example, the user may alter for each particular year the number of employees which may have access to the software program. A specific roll out change in field 111 for a particular year can change the financial analysis result provided in FIG. 9, which change can be visualized in real time in graphical image 110.

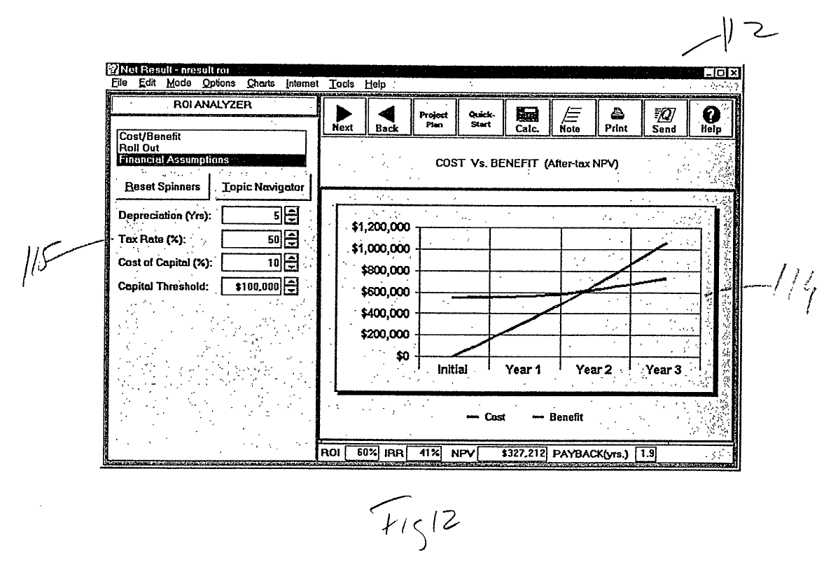

FIG. 12 depicts a display 112 that shows a graphical image 114 representative of changes in the financial assumptions for the company. Such changes can be made in field 115 and permits the user to play out a further “what-if” situation.

Turning again to FIG. 1, it could be seen that the information collected by the display 20 can be provided to the knowledge base 16. The knowledge base 16, in one embodiment, is a computer database such as the Microsoft Access computer database that stores empirically determined data that has been drawn from the knowledge source 12.

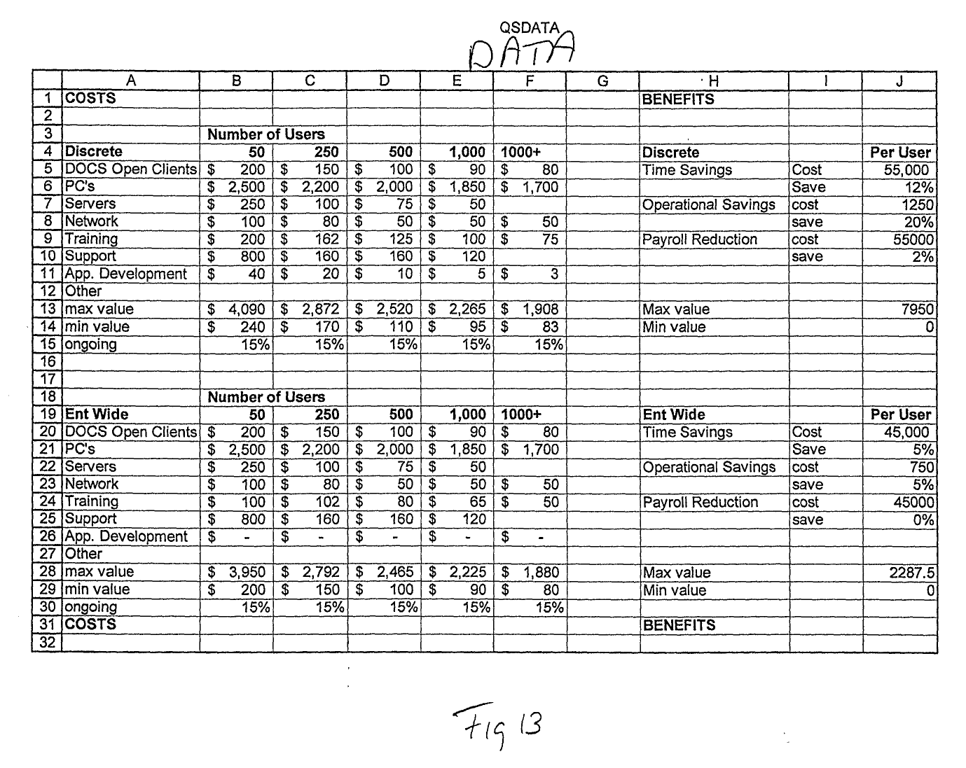

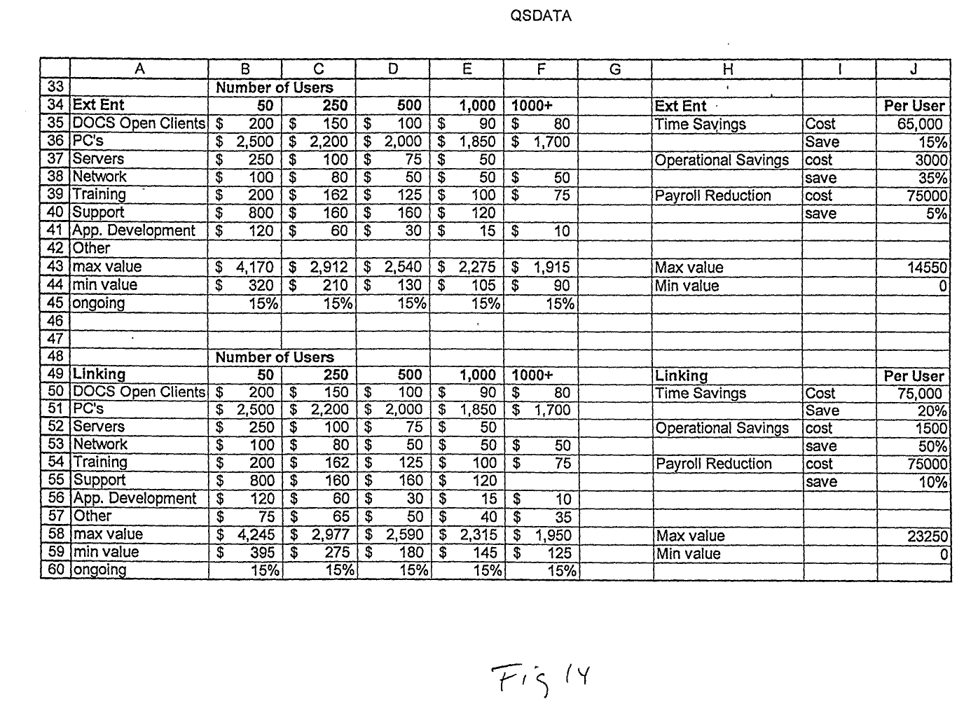

FIGS. 13 and 14 depict one example of the type of empirically determined data that can be drawn from the knowledge source 12 and stored within the database that comprises a portion of the knowledge base 16. The data can include, as shown in FIG. 13, information about the costs and benefits that are encountered when employing the software product under consideration. Moreover, the database can be organized so that costs and benefits are grouped together according to a particular type of framework, wherein each framework is identified by the constraints that have been examined during the data collection process. For example, turning to FIG. 13, it can be seen that the database includes costs and benefits that are commonly incurred with deploying the software product. Moreover, FIG. 13 shows that the costs and benefits can be grouped according to the characteristic representative of the type of deployment, for instance, the number of users, as well as whether the deployment will be discreet, enterprise wide, or enterprise extended (a situation where the software is deployed on some desk PC's within a company and linked electronically to the company's corporate clients). Within each of the frameworks, data stored in the database can be empirically determined from the analysis of the data contained within the knowledge source 12. Accordingly, from an analysis of knowledge source 12, it can be seen that a fundamental constraint on the costs and benefits for deploying a software product turns on the number of users that will employ the software product, as well as the type of deployment being practiced, such as an enterprise wide deployment or a linking deployment to external corporate clients. For example, it is understood that an enterprise wide deployment is more complex and takes a higher level of skill, training, support and network infrastructure than a discreet deployment system. On the other hand, it is understood that an enterprise wide deployment can lead to greater benefits for a particular software product than a discreet deployment may provide.

The empirically determined data for each of the framework can include information that has been determined through an empirical analysis of the knowledge source 12, which information is to be directly related to providing a meaningful financial analysis of the proposed software deployment. For example, the database depicted in FIGS. 13 and 14 identifies that for the framework of a discrete deployment, the costs of the deployment turn in part on the price of personal computers, servers, training, application development, and other factors. The valuations provided for these factors, such as the price of the personal computers, can be empirically determined from the knowledge source 12, and can generally be representative of industry benchmark data. Alternatively, in optional embodiments of the invention, the user can, in an optional step, access directly data stored within the knowledge base 16 and change that data to be more relevant to the user's particular situation. For example, a large computer institution may be able to purchase computers at a greatly reduced rate than that which is the industry benchmark cost. Accordingly, a sophisticated user can enter into the database and change the costs identified for personal computers to be one that is more correct for that particular user. FIG. 13 further includes benchmark data, such as including the effect of an economy of scale on the purchase price of PC's, servers, licenses on software, and other costs.

The knowledge base 16 therefore provides a plurality of frameworks that can be selected according to the constraints entered by the user to provide data that can be forwarded to a processor, such as the spreadsheet 18 depicted in FIG. 1. To make the financial analysis more accurate for the user, further constraints relating to the user experience, and current automation of task being supplanted by the software product can be employed for adjusting the data within the selected framework. For example, the slider bar 64, depicted in FIG. 5, can be adjusted by the user as described above, and a multiplier factor can be employed for adjusting the data provided by the framework to yield a more meaningful financial analysis for the user's particular deployment. In particular, the multiplier of the experience level can yield a number that represents a weighting factor that quantifies the impact the user's experience will have on the cost/benefit analysis. This weighting factor can be transmitted along with the framework data from the knowledge base 16 to the processor 18. Similarly, the user can input constraint data through the user interface 38 and user interface 80, each of which provides a multiplier factor that is representative of a value or weighting factor. The value or weighting factor representative of the multiplier factor provided by user interface 38 can be employed for adjusting the framework data to take into consideration the industry in which the software is used. Likewise, the value or weighting factor representative of the multiplier factor provided by user interface 80 can be employed for adjusting the fraemwork data to take into consideration the level of automation currently employed by the user for the task that is to be supplanted by the software product. These multiplier factors can be forwarded with the framework data to the processor 18 for performing the financial analysis.

The processor 18, shown in FIG. 1, can receive from the knowledge base 16 a set of data that can be employed for generating the financial analysis. The processor 18 can be a conventional spreadsheet, such as a Microsoft Excel spreadsheet, containing formula and data for performing the financial analysis required for providing the user with a meaningful understanding of the valuation of the software product.

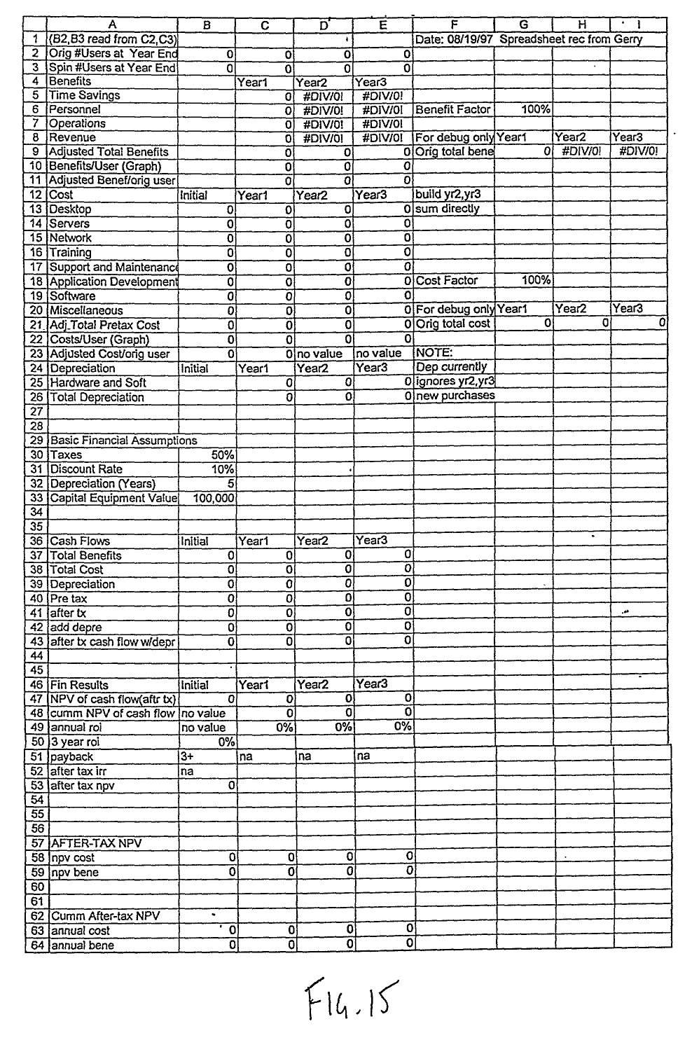

FIG. 15 depicts one example of a spreadsheet that is organized for taking information from the knowledge base 16 and generating a financial analysis for the user. Specifically, FIG. 15 shows a spreadsheet formula written for a Microsoft Excel spreadsheet that is used, in the depicted embodiment, for an ROI calculation. In particular, the spreadsheet uses standard industry formula for financial analysis and takes into account various factors, including “benefits” factors, examples of which include, information relating to time savings, personnel, and revenue, “costs” factors, examples of which include, information relating to the network, training, and support, and “depreciation”, examples of which include inform relating to hardware and software. It should be appreciated that other financial analyses applicable in the art may also be performed with the present invention using standard industry financial formulas, examples of which include IRR, PAYBACK, and NPV. For instance, the formula for calculating the NPV can be obtained from Van Horne, James C., Financial Management and Policies, 1989 (Prentice Hall), which is hereby incorporated herein by reference.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains, and as fall within the scope of the appended claims.

What is claimed is:

1. A process for analyzing financial data associated with deploying a software product to aid an organization in a purchase evaluation of the software product, the process comprising:
providing a knowledge base having a first set of information representative of criteria that have been empirically determined to provide a financial analysis of the software product;
collecting a second set of information representative of factors involved in the deployment the software product to aid in the financial analysis; and
processing the first and second sets of information to generate a signal representative of the financial analysis.

2. A process as set forth in claim 1, wherein in the step of providing, the first set of information includes costs for upgrading current technology infrastructure in connection with the utilization of the software product.

3. A process as set forth in claim 1, wherein in the step of providing, the first set of information includes costs for training and supporting users in connection with the utilization of the software product.

4. A process as set forth in claim 1, wherein in the step of providing, the first set of information includes benefits relating to time, operation and/or payroll savings in connection with the utilization of the software product.

5. A process as set forth in claim 1, wherein the step of collecting the second set of information includes obtaining data from a user response regarding an industry within which the software product is to be utilized.

6. A process as set forth in claim 1, wherein the step of collecting the second set of information includes obtaining data from a user response regarding a total number of users utilizing the software product.

7. A process as set forth in claim 1, wherein the step of collecting the second set of information includes obtaining data from a user response regarding an average salary amount for each user utilizing the software product.

8. A process as set forth in claim 1, wherein the step of collecting the second set of information includes obtaining data from a user response regarding the manner and scope of utilization of the software product within the organization.

9. A process as set forth in claim 1, wherein the step of collecting the second set of information includes obtaining data from a user response regarding the level of experience of the organization in deploying new software technology.

10. A process as set forth in claim 1, wherein the step of collecting the second set of information includes obtaining data from a user response regarding the level of automation available for implementing a new software product.

11. A process as set forth in claim 1, wherein the step of processing the first and second sets of information includes providing a spreadsheet having empirically determined formulas for performing a financial analysis.

12. A knowledge base having information representative of criteria associated with a financial analysis for a purchase of a software product, the knowledge base comprising:
question information representative of questions for collecting variable information from a user, the variable information being representative of an environment within which the software product will be deployed; and
sets of empirically determined data representative of costs and benefits associated with the purchase of the software product, and organized for being accessed as a function of the variable information collected from the user.

13. A knowledge base as set forth in claim 12, wherein the variable information includes data from a user response regarding an industry within which the software product is to be utilized.

14. A knowledge base as set forth in claim 12, wherein the variable information includes data from a user response regarding a total number of users utilizing the software product.

15. A knowledge base as set forth in claim 12, wherein the variable information includes data from a user response regarding an average salary amount for each user utilizing the software product.

16. A knowledge base as set forth in claim 12, wherein the variable information includes data from a user response regarding the manner and scope of utilization of the software product within the organization.

17. A knowledge base as set forth in claim 12, wherein the variable information includes data from a user response regarding the level of experience of the organization in deploying new software technology.

18. A knowledge base as set forth in claim 12, wherein the variable information includes data from a user response regarding the level of automation available for implementing a new software product.

19. A knowledge base as set forth in claim 12, wherein the empirical data includes costs for upgrading current technology infrastructure in connection with the utilization of the software product.

20. A knowledge base as set forth in claim 12, wherein the empirical data includes costs for training and supporting users in connection with the utilization of the software product.

21. A knowledge base as set forth in claim 12, wherein the empirical data includes benefits relating to time, operation and/or payroll savings in connection with the utilization of the software product.

22. A process for guiding a user in a purchase of a software product, the process comprising the steps of:
asking at least one question to obtain variable information from the user, the variable information being representative of an environment within which the software product will be deployed;
selecting from a knowledge base, as a function of the variable information provided by the user, a set of empirically determined data; and
applying the selected set of empirically determined data to a spreadsheet having empirically determined formulas for performing a financial analysis, so as to obtain information representative of a financial analysis as a function of the selected set of empirically determined data; and
displaying the information representative of the financial analysis in order to guide the user in the purchase of the software product.
